(19) United States
(12) Patent Application Publication
(10) Pub. No.: US 2025/0264387 A1
(43) Pub. Date: Aug. 21, 2025

(54) METHODS TO OVERCOME PREFERRED ORIENTATION IN CRYO-SAMPLES FOR SINGLE PARTICLE ANALYSIS

(71) Applicant: ECOLE POLYTECHNIQUE FEDERALE DE LAUSANNE (EPFL), Lausanne (CH)

(72) Inventors: Ulrich LORENZ, Lausanne (CH); Gabriele BONGIOVANNI, Eindhoven (NL); Olivier Florian HARDER, Lausanne (CH); Jonathan VOSS, Littleton, CO (US); Marcel DRABBELS, Le Mont sur Lausanne (CH); Monique STRAUB, Lausanne (CH); Nathan MOWRY, Lausanne (CH)

(21) Appl. No.: 19/055,751

(22) Filed: Feb. 18, 2025

Related U.S. Application Data
(60) Provisional application No. 63/555,160, filed on Feb. 19, 2024.

(51) Int. Cl. G01N 1/44; G01N 1/42

(52) U.S. Cl. CPC G01N 1/44; G01N 1/42

(57) ABSTRACT

A method for reducing a preferred orientation of particles in a cryo-sample includes receiving the cryo-sample in a vacuum chamber, depositing amorphous ice onto the cryo-sample while the cryo-sample is in the vacuum chamber, delivering an energy pulse to the cryo-sample in the vacuum chamber to temporarily melt the amorphous ice on the cryo-sample to liquid water to promote movement of the particles in the cryo-sample to a changed orientation different from the preferred orientation, and allowing the liquid water to revitrify to amorphous ice upon cessation of the energy pulse to fix or trap the particles in the cryo-sample in the changed orientation.

### CROSS-REFERENCE TO RELATED APPLICATION

The present application claims priority and benefit of U.S. Provisional Patent Application No. 63/555,160 filed Feb. 19, 2024, the entire disclosure of which is incorporated herein by reference.

### FIELD OF THE DISCLOSURE

The present disclosure relates to the field of cryo-electron microscopy (cryo-EM) for studying particle systems at near-atomic resolution. Such particle systems may be, for example, protein systems, biological systems, inorganic chemical systems, and the like.

### BACKGROUND OF THE DISCLOSURE

Structure determination of proteins and other particle systems has made rapid progress in the last decade, particularly due to resolution improvements in cryo-EM and the advent of machine learning approaches for structure prediction. However, achieving further resolution improvements in cryo-EM is made more difficult for many cryo-samples due to a preference of particles for specific orientations in the sample. These preferred orientations contribute more information to the corresponding observation angles, but information for other observation angles needed for high-resolution reconstruction is underrepresented or even absent.

While tilting the cryo-sample during imaging has been used to mitigate the effects of preferred orientation, tilting the cryo-sample to high angles reduces the obtainable resolution.

The inventors have observed that fast laser melting and revitrification of cryo-samples for time-resolved cryo-EM studies of dynamic particle systems is accompanied by an unexpected side effect, namely a more homogeneous angular distribution of the particles.

### SUMMARY OF THE DISCLOSURE

The present disclosure describes methods and apparatuses for overcoming preferred orientations in cryo-samples by exploiting the beneficial side effect of laser melting and revitrification.

An apparatus for reducing a preferred orientation of particles in a cryo-sample according to an embodiment of the present disclosure generally comprises a vacuum chamber for receiving the cryo-sample, a deposition system in communication with the vacuum chamber, and an energy source operable to deliver an energy pulse to the cryo-sample in the vacuum chamber. The deposition system is operable to deposit ice on the cryo-sample. The energy pulse delivered to the cryo-sample temporarily melts the ice on the cryo-sample to liquid water to promote movement of the particles in the cryo-sample to a changed orientation different from the preferred orientation. When the energy pulse ceases, the liquid water revitrifies to amorphous ice to fix the particles in the cryo-sample in the changed orientation.

The deposition system may comprise a reservoir configured to contain a liquid and a gas dosing valve having an inlet in flow communication with the reservoir and an outlet in flow communication with the vacuum chamber, wherein the gas dosing valve is operable to convey vapor from the liquid in the reservoir to the vacuum chamber such that at least a portion of the vapor is deposited on the cryo-sample. Deposition liquid in the reservoir may be pure liquid water or liquid water in solution with at least one other constituent, such that the liquid water resulting from melting the ice on the cryo-sample is pure liquid water or liquid water in solution with at least one other constituent.

A method for reducing a preferred orientation of particles in a cryo-sample according to another embodiment of the present disclosure generally comprises receiving the cryo-sample in a vacuum chamber, depositing ice onto the cryo-sample while the cryo-sample is in the vacuum chamber, delivering an energy pulse to the cryo-sample in the vacuum chamber to temporarily melt the ice on the cryo-sample to liquid water to promote movement of the particles in the cryo-sample to a changed orientation different from the preferred orientation, and allowing the liquid water to revitrify to amorphous ice upon cessation of the energy pulse to fix the particles in the cryo-sample in the changed orientation.

The disclosure provides a non-destructive means for improving high-resolution cryo-EM imaging of single particles by broadening the distribution of particle orientations in a cryo-sample.

### BRIEF DESCRIPTION OF THE DRAWING VIEWS

The patent or application file contains at least one drawing executed in color. Copies of this patent or patent application publication with color drawing(s) will be provided by the Office upon request and payment of the necessary fee.

The nature and mode of operation of the present disclosure will now be more fully described in the following detailed description taken with the accompanying drawing figures, in which:

FIG. 1 is a schematic view illustrating a cryo-electron microscope comprising an apparatus for overcoming preferred particle orientation in a cryo-sample according to an embodiment of the present disclosure;

FIG. 2 is a detail view of a cryo-sample received by the cryo-EM of FIG. 1, wherein particles in the cryo-sample exhibit a preferred orientation;

FIG. 3 is a schematic view illustrating a deposition system of the apparatus for overcoming preferred particle orientation in greater detail according to an embodiment of the present disclosure;

FIG. 4 is a view similar to that of FIG. 2, wherein ice is deposited on the cryo-sample in accordance with an embodiment of the present disclosure;

FIG. 5 is a view similar to that of FIG. 4, wherein the ice on the cryo-sample is melted to a liquid state by an energy pulse in accordance with an embodiment of the present disclosure;

FIG. 6 is a view similar to that of FIG. 5, illustrating change in orientation of particles in the cryo-sample away from the preferred orientation while immersed in the liquid water;

FIG. 7 is a view similar to that of FIG. 6, wherein the cryo-sample is revitrified to freeze the particles in the cryo-sample in their changed orientations;

FIG. 8 is a flow diagram illustrating a method for overcoming preferred particle orientation in a cryo-sample according to an embodiment of the present disclosure;

FIG. 9A is an image of a 50S ribosome particle obtained by conventional cryo-EM observation and reconstruction without melting and revitrification of the cryo-sample;

FIG. 9B is an image similar to that of FIG. 9A, wherein the image was obtained after the cryo-sample underwent melting and revitrification;

FIG. 9C is an image similar to those of FIGS. 9A and 9B, wherein the image was obtained after the cryo-sample underwent deposition, melting, and revitrification in accordance with an embodiment of the present disclosure;

FIG. 10A is a graphical map indicating the number of image views obtained throughout the range of azimuth viewing angles and the range of elevation viewing angles by conventional cryo-EM observation and reconstruction without melting and revitrification of the cryo-sample;

FIG. 10B is a graphical map similar to that of FIG. 10A indicating the number of image views obtained throughout the range of azimuth viewing angles and the range of elevation viewing angles by cryo-EM observation and reconstruction after melting and revitrification of the cryo-sample;

FIG. 10C is a graphical map similar to those of FIGS. 10A and 10B indicating the number of image views obtained throughout the range of azimuth viewing angles and the range of elevation viewing angles by cryo-EM observation and reconstruction after deposition, melting, and revitrification of the cryo-sample in accordance with an embodiment of the present disclosure;

FIG. 11A is a graphical map indicating the image resolution obtained throughout the range of azimuth viewing angles and the range of elevation viewing angles by conventional cryo-EM observation and reconstruction without melting and revitrification of the cryo-sample;

FIG. 11B is a graphical map similar to that of FIG. 11A indicating the image resolution obtained throughout the range of azimuth viewing angles and the range of elevation viewing angles by cryo-EM observation and reconstruction after melting and revitrification of the cryo-sample; and

FIG. 11C is a graphical map similar to those of FIGS. 11A and 11B indicating the image resolution obtained throughout the range of azimuth viewing angles and the range of elevation viewing angles by cryo-EM observation and reconstruction after deposition, melting, and revitrification of the cryo-sample in accordance with an embodiment of the present disclosure.

### DETAILED DESCRIPTION OF THE DISCLOSURE

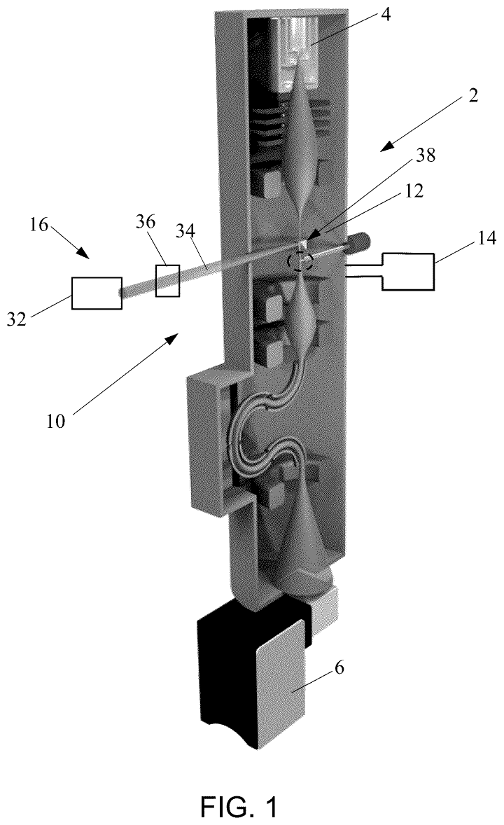

FIG. 1 is a schematic view illustrating a cryo-electron microscope 2 modified to comprise an apparatus 10 for overcoming preferred particle orientation in a cryo-sample according to an embodiment of the present disclosure. Cryo-electron microscope 2 may be, for example, a Jeol 2200FS transmission electron microscope using a Gatan Elsa single-tilt cryo holder. Cryo-electron microscope 2 may include a vacuum chamber 12 for receiving a cryo-sample, an electron source 4 for generating an electron beam focused on a cryo-sample in vacuum chamber 12, and a camera 6 for capturing image data of the cryo-sample. Apparatus 10 for overcoming preferred particle orientation generally comprises the vacuum chamber 12, a deposition system 14 in communication with vacuum chamber 12, and an energy source 16 operable to deliver an energy pulse to the cryo-sample in vacuum chamber 12.

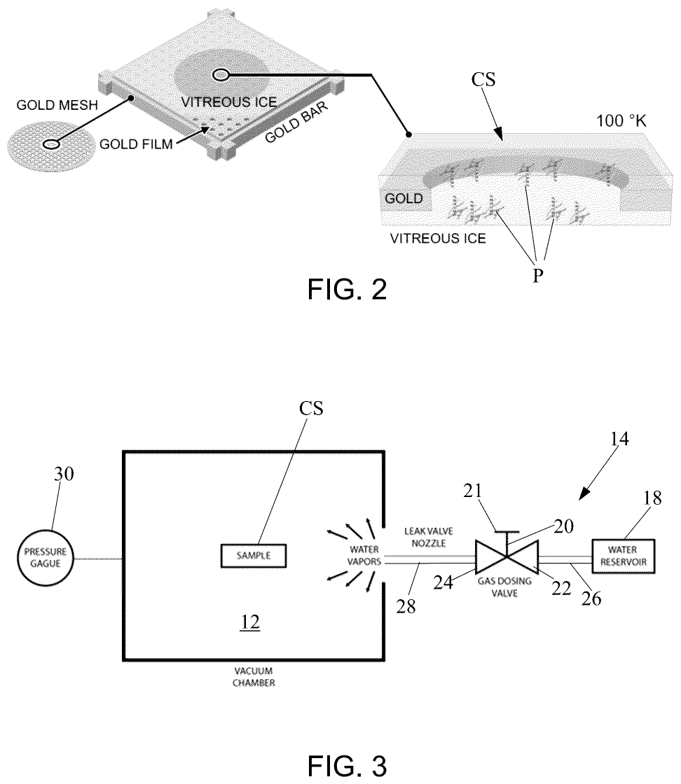

FIG. 2 is a detail view of a cryo-sample CS to be received by cryo-EM 2 of FIG. 1, wherein particles P in the cryo-sample exhibit a preferred orientation. For sake of illustration, the preferred orientation of particles P in Fig. is a generally vertical orientation, however the term “preferred orientation” encompasses other (i.e., non-vertical) particle orientations and ranges of orientations that are predominant within a cryo-sample. Cryo-sample CS may be prepared on an UltrAuFoil R1.2/1.3 300 mesh grid (source: Quantifoil). The grid may be plasma cleaned for one minute to render it hydrophilic, for example using a glow discharge cleaning system such as the an easiGlow™ system (source: Ted Pella). Subsequently, a quantity of sample solution may be applied to the specimen grid and the sample plunge-frozen, for example using a Vitrobot Mark IV (source: Thermo Fisher Scientific) with three seconds blotting time, 95% relative humidity at a temperature of 10° C. After plunge freezing, cryo-sample CS is inserted into vacuum chamber 12. Cryo-sample CS is maintained at a cryogenic temperature such as approximately 100° K (about −173° C.). As illustrated in FIG. 2, plunge freezing traps particles P of cryo-sample 2 in a volume of vitreous ice wherein the particles exhibit one or more preferred orientations.

FIG. 3 schematically depicts deposition system 14 according to one variant of the present disclosure. Deposition system 14 is operable to deposit ice on cryo-sample CS. As shown in FIG. 3, deposition system 14 may include a reservoir 18 configured to contain a liquid such as pure water or a liquid solution containing water as a constituent, and a gas dosing valve 20 having an inlet 22 in flow communication with reservoir 18 and an outlet 24 in flow communication with vacuum chamber 12. For example, inlet 22 may be connected to reservoir 18 by a stainless steel pipe or conduit 26, outlet 24 may be connected to vacuum chamber 12 by a stainless steel pipe or conduit 28. As shown in FIG. 3, a pressure gauge 30 may be installed to measure and indicate pressure within vacuum chamber 12.

Deposition system 14, including reservoir 18, may be maintained within a temperature range such that the vapor pressure of liquid water in reservoir 18 is approximately 10-20 mbar. The vacuum pressure inside the vacuum chamber 12 is much less than 10-20 mbar (e.g., about 10-7 mbar), so there exists a pressure gradient that causes water vapor to travel from reservoir 18 through conduit 26 to inlet 22 of gas dosing valve 20. Gas dosing valve 20 includes a manual and/or automatic valve controller 21 whereby gas dosing valve 20 may be selectively opened and closed in a controlled manner to allow a desired amount of water vapor to travel through the gas dosing valve and exit the gas dosing valve via outlet 24. The water vapor then travels through conduit 28 and into vacuum chamber 12. A portion of the water vapor entering vacuum chamber 12 will condense and be deposited onto cryo-sample CS as ice. In a preferred protocol, the cryo-sample holder is maintained at a cryogenic temperature low enough so that the deposited ice is amorphous ice, however the cryo-sample holder may be held at a higher temperature during deposition such that crystalline (i.e., non-amorphous) ice is deposited without straying from the disclosure. Thus, gas dosing valve 20 is operable to control how much water vapor is allowed to travel into the vacuum chamber, thereby indirectly controlling a thickness of amorphous ice deposited on the cryo-sample. For example, under constant conditions, holding gas dosing valve 20 open for a longer time period will increase the thickness of amorphous ice deposited on the cryo-sample relative to holding the gas dosing valve 20 open for a shorter time period. Gas dosing valve may be a commercially available gas dosing valve used for vacuum systems, for example a Balzers UDV235 gas dosing valve.

Energy source 16 is operable to deliver an energy pulse to the cryo-sample in vacuum chamber 12 to temporarily melt the ice on the cryo-sample to liquid water to promote movement of particles P in the cryo-sample to a changed orientation different from the preferred orientation. Energy source 16 may include an illumination source 32 emitting an illumination beam 34, a pulse modulator 36 in the path of illumination beam 34 for modulating the illumination beam into discrete pulses at a predetermined pulse frequency, and beam deflection and focusing optics 38 for directing and focusing illumination beam 34 onto an area of cryo-sample CS. Illumination source 32 may be, for example, a laser that emits light at a wavelength of 532 nanometers, such as a Ventus 532 laser. Other laser sources having the same emission wavelength or different emission wavelengths may be used. Non-laser light sources emitting light in broader wavelength bands may also be used. Pulse modulator 36 may take the form of an acousto-optic modulator, a Pockels cell, a very fast mechanical shutter that briefly unblocks the beam, or another device for creating a brief pulse. For example, a suitable acousto-optic modulator is available from AA Opto Electronic of Orsay, France. Each pulse may be in a range of several nanoseconds through 100s of microseconds (μs) in duration. Pulses on the order of 20 μs in duration have been found effective in practicing the disclosure. Alternatively, illumination source 32 may be a laser source configured to emit laser pulses each of a predetermined duration within the stated duration range instead of emitting a continuous beam, in which case pulse modulator 36 may be omitted. Optics 38 may include a mirror arranged to direct illumination beam 34 such that the beam strikes a plane of cryo-sample CS at normal incidence or at an angle of incidence other than 90°. Illumination beam 34 may be focused such that it illuminates an area on the order of 20 μm in width or diameter, or another sized area suitable for experimental purposes.

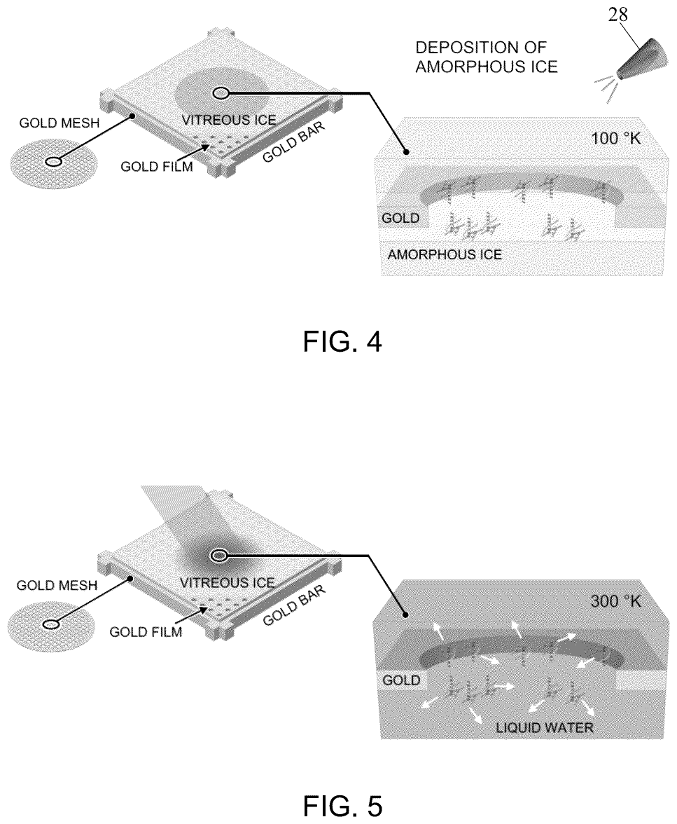

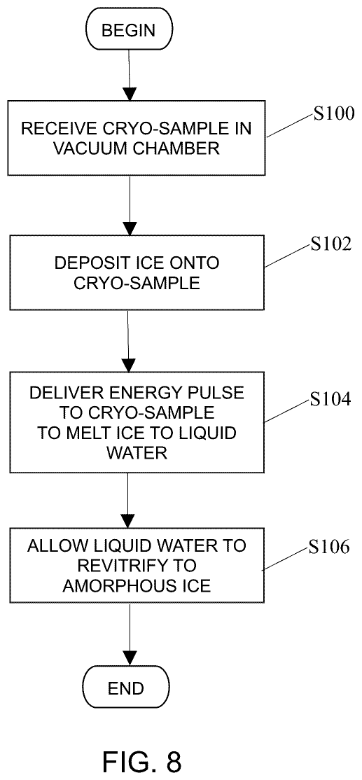

FIGS. 4-8 illustrate usage of apparatus 10 for overcoming preferred particle orientation in a cryo-sample according to an embodiment of the present disclosure. First, the plunge-frozen cryo-sample CS is inserted into and received in vacuum chamber 12. This step is indicated as step S100 in the flow diagram of FIG. 8. Next, as illustrated in FIG. 4 and indicated by step S102 in FIG. 8, ice is deposited onto cryo-sample CS while the cryo-sample is in vacuum chamber 12 by operation of deposition system 14. Applicant has found that depositing ice about 20 nm in thickness onto cryo-sample CS is suitable for purposes of the present disclosure, and that depositing ice greater than about 100 nm in thickness onto cryo-sample CS may be unsuitable for purposes of the present disclosure. To control the thickness of the deposition, operating parameters of deposition system 14 such as pressure and the time period gas dosing valve 20 is kept open may be varied and resulting deposition thicknesses measured to calibrate the deposition system. As indicated in FIG. 4, the cryo-sample CS is maintained at about 100° K during the deposition step.

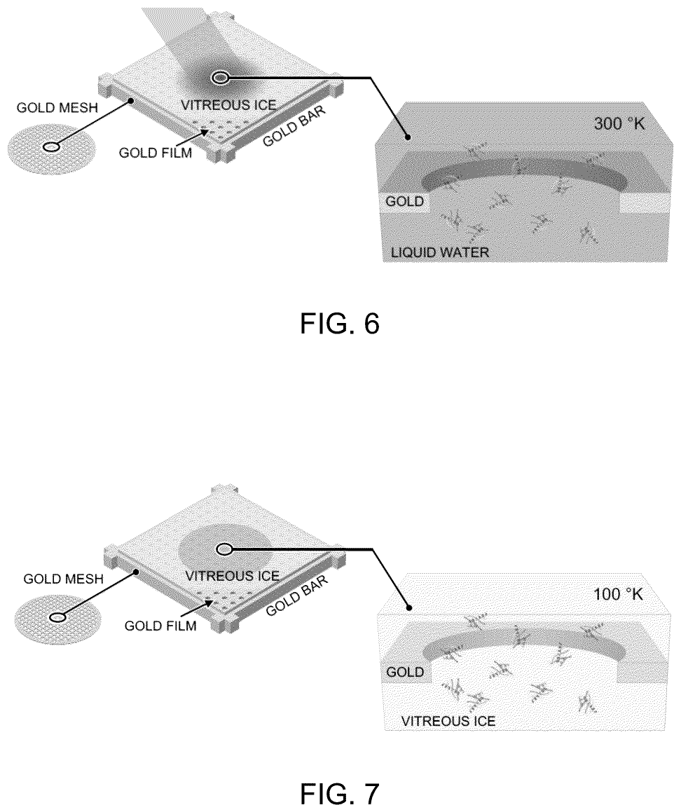

Next, as shown in FIGS. 5 and 6 and indicated by step S104 in FIG. 8, an energy pulse is delivered to cryo-sample CS in vacuum chamber 12 to temporarily melt the ice on the cryo-sample to liquid water. Due to the energy pulse, the local temperature in a portion of cryo-sample CS increases to a temperature above the freezing point of water, for example approximately 300° K (about 27° C.). This step promotes movement of particles P in the cryo-sample to a changed orientation different from the preferred orientation. This aspect is illustrated schematically in FIGS. 5 and 6. The energy pulse may be delivered using energy source 16 described above.

Upon cessation of the energy pulse, the liquid water of cryo-sample CS is allowed to revitrify to amorphous ice. This step is illustrated in FIG. 7 and indicated by step S106 in FIG. 8. When the liquid water revitrifies, it fixes (i.e., traps or locks) particles P in the cryo-sample in the changed orientation. In other words, the revitrification traps particles P in a non-equilibrium distribution of angular orientations. As a result, the undesirable preferred orientation of particles P depicted in FIG. 4 is overcome.

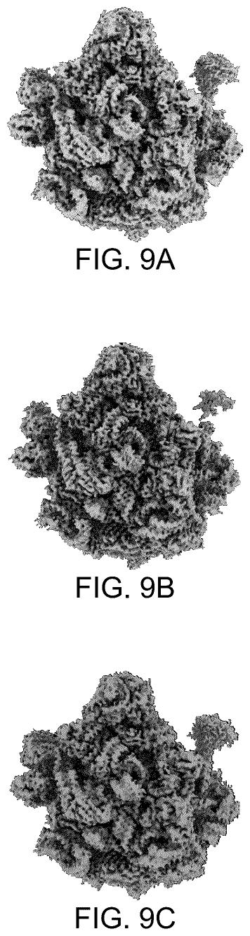

Utility of the present disclosure is demonstrated with reference to FIGS. 9A through 11C. Single particle images of a 50S ribosome particle were obtained by conventional cryo-EM observation and reconstruction without melting and revitrification of the cryo-sample (FIG. 9A), by cryo-EM observation and reconstruction after the cryo-sample underwent melting and revitrification (FIG. 9B), and by cryo-EM observation and reconstruction after the cryo-sample underwent deposition, melting, and revitrification in accordance with an embodiment of the present disclosure. For high-resolution imaging, the cryo-sample was transferred to a Titan Krios G4 cryo-EM (source: Thermo Fisher Scientific) and single-particle reconstructions were generated using cryoSPARC software to yield the near-atomic resolution images of FIGS. 9A, 9B, and 9C.

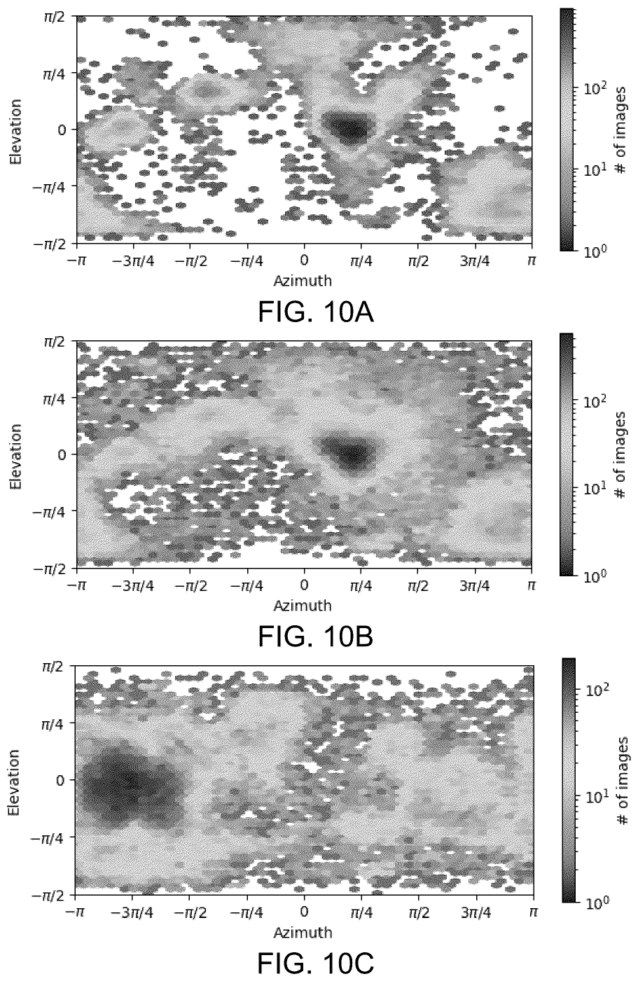

FIG. 10A is a color-coded graphical map indicating the number of image views obtained throughout the range of azimuth viewing angles and the range of elevation viewing angles by conventional cryo-EM observation and reconstruction without melting and revitrification of the cryo-sample. FIG. 10B is a similar color-coded graphical map where the cryo-sample underwent melting and revitrification. FIG. 10C is a similar color-coded graphical map where the cryo-sample underwent deposition, melting, and revitrification in accordance with an embodiment of the present disclosure. In the map of FIG. 10A, where particles P are in their preferred orientation, the distribution of available views is highly concentrated in a narrow range of angular orientations and elevations and thus deficient at other view orientations. In the map of FIG. 10B, where melting and revitrification has taken place without any deposition, some initial broadening of the distribution of views can be seen. In the map of FIG. 10C, where melting and revitrification has taken place after deposition, a much greater broadening of the distribution of views is evident. The disclosure makes it possible to capture a completely different set of views and populate views that were previously non-existent. The different particle orientation obtained by the disclosure provides more views, which for some applications may be even more important than just the image resolution.

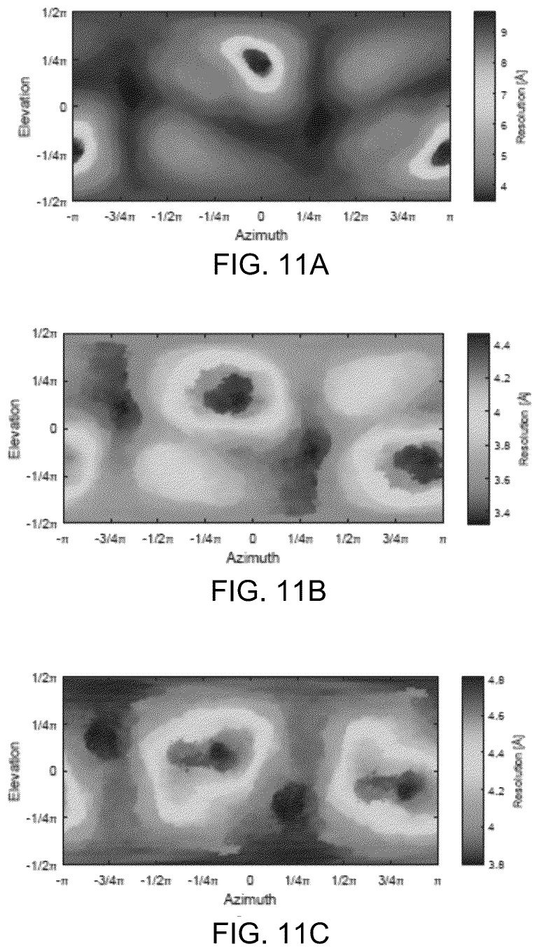

The impact of having a wider distribution of views on image resolution is apparent from FIGS. 11A through 11C. FIG. 11A is a color-coded graphical map indicating the image resolution obtained throughout the range of azimuth viewing angles and the range of elevation viewing angles by conventional cryo-EM observation and reconstruction without melting and revitrification of the cryo-sample. FIG. 11B is a similar color-coded graphical map where the cryo-sample underwent melting and revitrification. FIG. 11C is a similar color-coded graphical map where the cryo-sample underwent deposition, melting, and revitrification in accordance with an embodiment of the present disclosure. In the map of FIG. 11A, resolution is unevenly spread in a range of just over 9 Angstoms to just under 4 Angstroms. In the map of FIG. 11B, resolution is distributed more evenly in a range of just over 4.4 Angstoms to just under 3.4 Angstroms. Finally, in the map of FIG. 11C, resolution is distributed in a comparable range of just over 4.8 Angstoms to just under 3.8 Angstroms, but with a greater proportion at the high-resolution end near 3.8 Angstroms.

The present disclosure is not limited to the deposition system 14 described above and shown in FIG. 3. Other types of deposition systems may be used. Such alternative deposition systems include physical vapor deposition systems that heat a source or bombard a source with high energy particles, chemical vapor deposition systems that use a chemical reaction to deposit ice, electron beam deposition systems that use a beam of electrons to bombard a source such that material vaporizes off the source and falls onto the cryo-sample, and solution deposition systems that spray a jet of droplets of pure water or an aqueous solutions onto the cryo-sample. A passive deposition system based on atmospheric condensation may also be used, whereby the cryo-sample is cooled, for example to about 100° K, and left in atmospheric or non-atmospheric conditions so that ice will naturally condense onto the cryo-sample.

While the present disclosure describes exemplary embodiments, the detailed description is not intended to limit the scope of the disclosure to the particular forms set forth. The disclosure is intended to cover such alternatives, modifications and equivalents of the described embodiments as may be apparent to one of ordinary skill in the art.

What is claimed is:

1. An apparatus for reducing a preferred orientation of particles in a cryo-sample, the apparatus comprising:
a vacuum chamber for receiving the cryo-sample;
a deposition system in communication with the vacuum chamber, wherein the deposition system is operable to deposit amorphous ice on the cryo-sample; and
an energy source operable to deliver an energy pulse to the cryo-sample in the vacuum chamber to temporarily melt the amorphous ice on the cryo-sample to liquid water to promote movement of the particles in the cryo-sample to a changed orientation different from the preferred orientation;
wherein the liquid water revitrifies to amorphous ice upon cessation of the energy pulse to fix the particles in the cryo-sample in the changed orientation.

2. The apparatus according to claim 1, wherein the deposition system comprises:
a reservoir configured to contain a liquid; and
a gas dosing valve having an inlet in flow communication with the reservoir and an outlet in flow communication with the vacuum chamber;
wherein the gas dosing valve is operable to convey vapor from the liquid in the reservoir to the vacuum chamber such that at least a portion of the vapor is deposited on the cryo-sample.

3. The apparatus according to claim 1, wherein the liquid water is pure liquid water or liquid water in solution with at least one other constituent.

4. The apparatus according to claim 1, wherein the energy source includes an illumination source emitting an illumination beam, a pulse modulator in a path of the illumination beam for modulating the illumination beam into discrete pulses at a predetermined pulse frequency, and beam deflection and focusing optics for directing and focusing the illumination beam onto an area of the cryo-sample.

5. The apparatus according to claim 4, wherein the illumination source is a laser light source.

6. The apparatus according to claim 5, wherein the laser light source emits light at a wavelength of 532 nanometers.

7. The apparatus according to claim 4, wherein the illumination source is a non-laser light source emitting light in a wavelength band.

8. The apparatus according to claim 4, wherein the pulse modulator includes an acousto-optic modulator, a Pockels cell, or a mechanical shutter.

9. The apparatus according to claim 1, wherein the energy source includes an illumination source configured to emit a pulsed illumination beam having pulses of a predetermined duration and deflection and focusing optics for directing and focusing the pulsed illumination beam onto an area of the cryo-sample.

10. The apparatus according to claim 9, wherein the illumination source is a pulsed laser light source.

11. The apparatus according to claim 10, wherein the pulsed laser light source emits light at a wavelength of 532 nanometers.

12. A method for reducing a preferred orientation of particles in a cryo-sample, the method comprising:
receiving the cryo-sample in a vacuum chamber;
depositing amorphous ice onto the cryo-sample while the cryo-sample is in the vacuum chamber;
delivering an energy pulse to the cryo-sample in the vacuum chamber to temporarily melt the amorphous ice on the cryo-sample to liquid water to promote movement of the particles in the cryo-sample to a changed orientation different from the preferred orientation; and
allowing the liquid water to revitrify to amorphous ice upon cessation of the energy pulse to fix the particles in the cryo-sample in the changed orientation.

13. The method according to claim 12, wherein the liquid water is pure liquid water or liquid water in solution with at least one other constituent.

14. The method according to claim 12, wherein the energy pulse is on the order of 20 μs in duration.
